(19) United States
(12) Patent Application Publication
(10) Pub. No.: US 2026/0112961 A1
(43) Pub. Date: Apr. 23, 2026

(54) APPARATUS AND METHOD OF POWER DELIVERY FOR A CURRENT SOURCE

(71) Applicant: Advanced Energy Industries, Inc., Denver, CO (US)

(72) Inventors: John Faustino Boqueo Begino, III, Pasig City (PH); Nathaniel Franco Neri, Taguig (PH); Ranil Margarijo Montaril, Quezon City (PH); Billie Simbahan Cruz, San Mateo (PH)

(21) Appl. No.: 18/924,190

(22) Filed: Oct. 23, 2024

(51) Int. Cl. H02M 1/08; H02M 1/00; H02M 1/32

(52) U.S. Cl. CPC H02M 1/08; H02M 1/0009; H02M 1/32

(57) ABSTRACT

A power supply system comprises a power supply configured to operate in a current source mode and in a voltage source mode and includes a defined current threshold value and a defined voltage threshold value. A controller is configured to, in response to a value of an output current of the output power reaching the defined current threshold value, control the power supply to operate in its current source mode. While controlling the power supply to operate in its current source mode, the controller is configured to calculate a current droop value configured to generate a modified current threshold value that extends beyond the defined current threshold value by the current droop value, generate a compensated pulse width modulation (PWM) signal based on a value of the output current and based on the modified current threshold value, and operate the power supply based on the compensated PWM signal.

### TECHNICAL FIELD

Aspects of the disclosure relate to power supply units and more particularly to controlling current supply to a load.

### BACKGROUND

A power supply unit (PSU) typically converts an incoming voltage into a different, output voltage. For example, an alternating current (AC) input voltage may be converted to a direct current (DC) voltage for use by electronic equipment. In another example, a first DC input voltage may be converted to a different DC voltage for use by the electronic equipment.

A multi-PSU system may include multiple PSUs coupled together in series to supply output power to a load. Balancing the power produced by each PSU to reduce differences between the supplied power among the PSUs helps to improve efficiency and reduce extra load stresses experienced by one or more PSUs if operated to produce more current than others in the system.

### SUMMARY

In accordance with one aspect of the present disclosure, a power supply system comprises a power supply configured to provide an output power to a load and configured to operate in a current source mode and in a voltage source mode, the power supply including a defined current threshold value and a defined voltage threshold value. A controller is coupled to the power supply and configured to, in response to a value of an output current of the output power reaching the defined current threshold value, control the power supply to operate in its current source mode. While controlling the power supply to operate in its current source mode, the controller is configured to calculate a current droop value configured to generate a modified current threshold value that extends beyond the defined current threshold value by the current droop value, generate a compensated pulse width modulation (PWM) signal based on a value of the output current and based on the modified current threshold value, and operate the power supply based on the compensated PWM signal.

In accordance with another aspect of the present disclosure, a method of controlling a power supply configured to provide an output power to a load, the power supply configured to operate in a current source mode and a voltage source mode. The method comprises sensing an output current of the output power via a current sensor, sensing an output voltage of the output power via a voltage sensor, and operating the power supply in the current source mode in response to a value of the output current being greater than or equal to a first current threshold value. During operation of the power supply in the current source mode, the method comprises calculating a first current droop value based on a value of the output voltage and based on the first current threshold value and calculating a first error compensation value based on the first current droop value, the first current threshold value, and the value of the output current. The method also comprises generating a first compensated pulse width modulation (PWM) signal based on the first error compensation value and operating the power supply based on the first compensated PWM signal to provide a first modified output power to the load.

In accordance with another aspect of the present disclosure, a power supply system comprises a first power supply configured to provide a first output power to a load, the first power supply configured to operate in a current source mode and a voltage source mode. A first current sensor is configured to provide a first current feedback signal based on an output current of the first output power, and a first voltage sensor is configured to provide a first voltage feedback signal based on an output voltage of the first output power. A first controller is coupled to the first power supply, to the first current sensor, and to the first voltage sensor. The first controller is configured to operate the first power supply in the current source mode in response to the output current of the first output power reaching a first defined current threshold value. While operating the first power supply in the current source mode, the first controller is further configured to calculate a first current droop value based on a value of the first voltage feedback signal and based on the first defined current threshold value and to calculate a first error compensation value based on the first current droop value, based on the first defined current threshold value, and based on a value of the first current feedback signal. The first controller is further configured to generate a first compensated pulse width modulation (PWM) signal based on the first error compensation value and operate the first power supply based on the first compensated PWM signal to provide a first modified output power to the load.

### BRIEF DESCRIPTION OF THE DRAWINGS

The drawings illustrate embodiments presently contemplated for carrying out the invention.

In the drawings:

FIG. 1 illustrates a schematic diagram of a multi-PSU system according to an aspect of this disclosure.

FIG. 2 is a block diagram of a multi-PSU system according to an aspect of this disclosure.

FIG. 3 illustrates a voltage-current characteristics curve according to an aspect of this disclosure.

FIG. 4 is a block diagram of a PSU according to an aspect of this disclosure.

FIG. 5 illustrates a method of PSU control according to an aspect of this disclosure.

FIG. 6 illustrates a voltage-current characteristics curve according to another aspect of this disclosure.

FIG. 7 illustrates a method of PSU control according to another aspect of this disclosure.

FIG. 8 illustrates a voltage-current characteristics curve according to another aspect of this disclosure.

FIG. 9 illustrates a method of PSU control according to another aspect of this disclosure.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

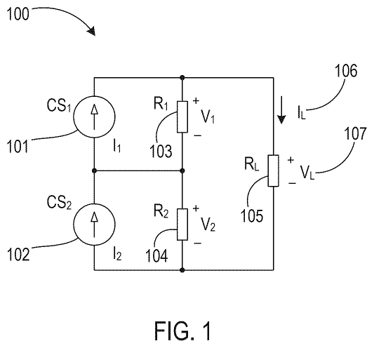

FIG. 1 illustrates a schematic diagram of a multi-power supply unit (PSU) system 100 according to an aspect of this disclosure. A pair of PSUs 101, 102 are shown being controlled in their current source mode. The PSUs 101, 102 are capable of being controlled in either the current source mode or in the voltage source mode as desired. The currents I1 and I2 are control parameters and are dependent on the operating point of each individual PSU 101, 102. A first resistor 103 (R1) represents the parallel impedance equivalent of the PSU 101, and second resistor 104 (R2) represents the parallel impedance equivalent of the PSU 102. The resistors 103, 104 are inversely proportional to the respective currents I1 and I2. A load 105 (represented by resistor) has a load current 106 supplied by the series-coupled PSUs 101, 102 and has a load voltage 107 supplied by the combination of voltages V1, V2 shown across respective resistors 103, 104. While the combination of V1 and V2 yields the load voltage, VL, 107, the voltage V1 may be different from the voltage V2. Embodiments of this disclosure reduce differences between voltages V1 and V2 of FIG. 1 to yield similar operating experiences by each PSU 101, 102. While not shown as having more PSUs coupled in series, it is understood that this disclosure describes reducing the voltage differences between all series-coupled PSUs in a system.

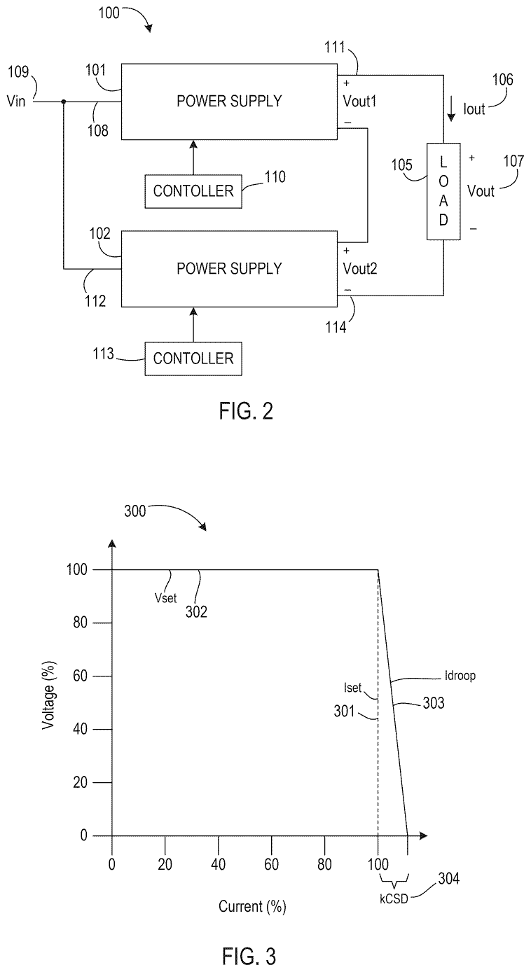

FIG. 2 is a block diagram of a multi-PSU system 100 of FIG. 1 according to an aspect of this disclosure. The first PSU 101 includes an input 108 configured to receive an input power or voltage 109. A controller 110 is configured to control the PSU 101 to produce an output power 111 including an output voltage and output current for delivery to the load 105. The second PSU 102 has an input 112 also configured to receive power from the input power 109. A controller 113 coupled with PSU 102 causes an output power 114 to be produced. While two controllers 110, 113 are shown, alternative embodiments contemplate a single controller coupled with both PSUs 101, 102 for separate control of each. Based on the methods disclosed herein, each controller 110, 113 controls its power supply (e.g., respective PSUs 101, 102) independently based on sensed output voltage and output current from the individual PSU without knowledge of the control sequence and output power of any other PSU in the system 100.

FIG. 3 illustrates a voltage-current characteristics curve (V-I curve) 300 according to an aspect of this disclosure. Referring to FIGS. 2 and 3, the two PSUs 101, 102 are configured to provide the load current 106 to the load 105. Each PSU 101, 102 is configured to operate in a current source mode and in a voltage source mode and includes a defined current threshold, Iset, 301 and a defined voltage threshold, Vset, 302. When controlled in its voltage source mode, the PSU 101, 102 operates in a constant voltage mode to output or provide a regulated output voltage 107 at the Vset 302. At no load, operation is in the constant voltage mode where Vout=100% of Vset 302. Each of the values of Vset 302 and Iset 301 may be determined to be at their 100% designed rating. However, other values may be used based on the system condition. The voltage source mode stays active while the output current is less than the Iset 301. In response to the load current 106 reaching the defined current threshold, Iset 301, control of the PSU 101, 102 switches to the current source mode, and the load current 106 follows a modified, sloped current threshold, Idroop, 303. The slope of the Idroop current 303 is based on the Vset 302 and a current share droop constant, kCSD, 304. The Idroop 303 is configured to cause the PSU 101, 102 to generate a modified current threshold value that extends beyond the defined current threshold value, Iset, 301 by a calculated current droop value correlating with a value of the voltage as explained hereinbelow.

As stated above, the outputs 111, 114 are coupled in series. As such, the output current Iout 106 flows through each PSU 101, 102 and the load 105. In particular, the load current 106 exits the first PSU 101 through a positive terminal of the output 111 and flows through the load 105 to a negative terminal of the output 114. The output current Iout then exits the second PSU 102 through a positive terminal of the output 114 and then enters the first PSU 101 through a negative terminal of the output 111. Additionally, an output voltage, Vout, 107 across the load 105 is equal to the sum of the output voltages Vout1, Vout2 of the PSUs 101, 102, respectively.

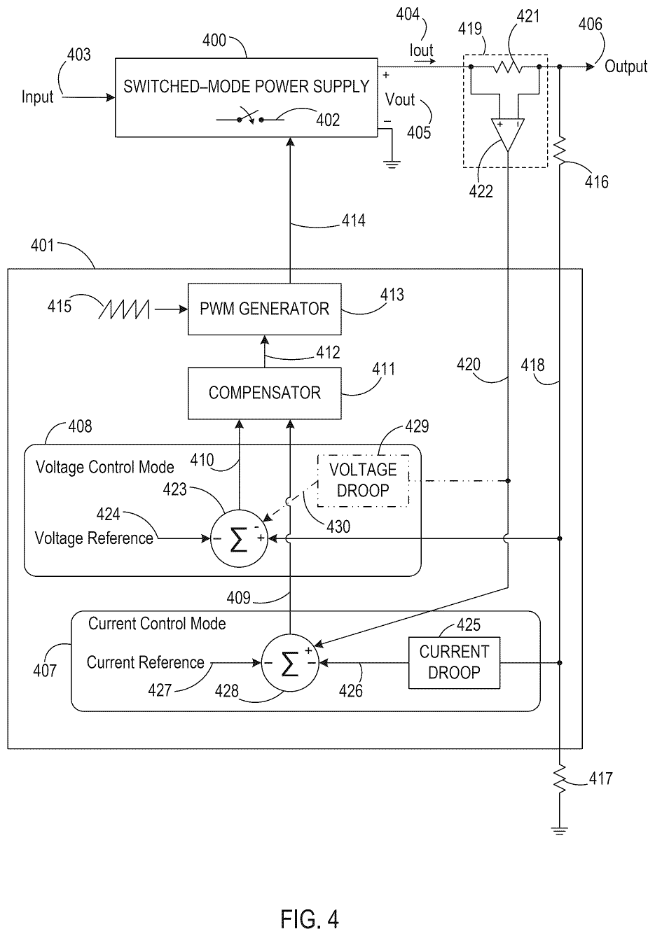

FIG. 4 is a block diagram of a PSU 400 (e.g., PSU 101 or 102) and controller 401 (e.g., controller 110 or 113) according to an aspect of this disclosure. The PSU 400 may represent either of the PSUs 101, 102 described above, and the controller 401 may represent either of the controllers 110, 113 described above. The PSU 400 includes a switched mode PSU having at least one power switch 402. The controller 401 is coupled to the at least one power switch 402 to control the source mode of the PSU 400 to convert power from an input 403 into an output current 404 and an output voltage 405 for delivery to an output 406. While not shown in FIG. 4, the output 406 is couplable to a load such as the load 105 of FIGS. 1, 2 or to the output 406 of another PSU for a series connection as described herein. Although FIG. 4 illustrates a switched mode power supply, it should be apparent that any suitable power supply may be employed.

As with the PSUs 101, 102 explained above, the PSU 400 is configured to operate in the current source mode and in the voltage source mode. Accordingly, the controller 401 includes a current control mode module 407 and a voltage control mode module 408, each configured to generate an error compensation value or signal 409, 410 for a compensator 411, which generates an error value or signal 412 to be used by a pulse width modulation (PWM) generator 413 to generate control signals 414 for the at least one power switch 402 based on, for example, a sawtooth signal 415.

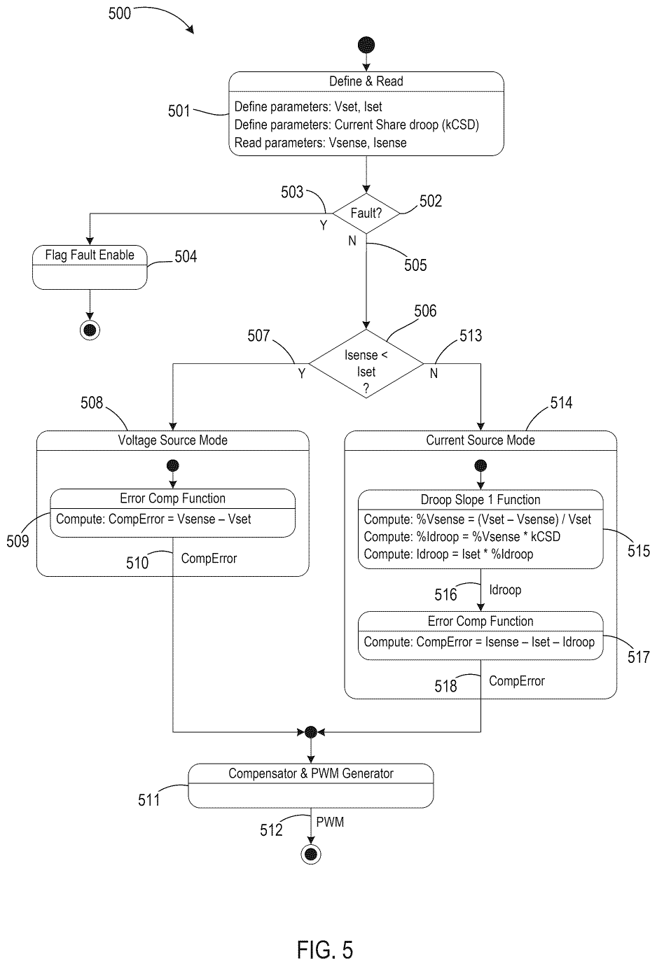

FIG. 5 illustrates a method of PSU control according to an aspect of this disclosure. Control of the PSU 400 pursuant to the V-I curve 300 of FIG. 3 will now be explained. Referring to FIGS. 3-5, a first droop control method 500 begins at step 501 by defining and reading parameters. The voltage threshold, Vset, 302 and current threshold, Iset, 301 are defined as well as the current share droop constant, kCSD, 304. An output voltage sensor (e.g., a resistor divider including first and second resistors resistor 416, 417) allows a sensed voltage value or signal, Vsense, 418 of the PSU output 406 to be read in as a parameter. A current sensing device 419 allows a sensed current value or signal, Isense, 420 of the PSU output 406 to be read in as a parameter. In one embodiment as shown, the current sensing device 419 may include a sense resistor 421 and a differential amplifier 422. The output current flowing through the resistor 421 creates a voltage drop across the resistor. The voltage across the resistor 421 is amplified by the differential amplifier 422 and is used as an output current feedback provided to the current and voltage control mode modules 407, 408. It is understood that the output voltage and current sensors shown and described above are merely examples, and that other types and embodiments of sensors may be used.

At step 502, the droop control method 500 determines whether a fault has occurred, either in the defined and read parameters or in any other process. If a fault has occurred (step 503), a flag fault enable module 504 is executed to address the fault as required. Should the fault be one where continued operation of the PSU is still possible, process control of the method 500 may return again to step 501. If no fault has occurred (step 505) sufficient to stop the method 500, the sensed current, Isense, is compared with the Iset defined parameter at step 506. In response to the sensed current, Isense, being lower than Iset (step 507) (e.g., Isense has not yet reached the defined current threshold, Iset, 301), the PSU 400 is operated in its voltage source mode. For example, for current values less than 100% of the V-I curve 300, the target of the output power (e.g., output power 111 or 114) is the defined voltage threshold Vset 302. Accordingly, a voltage source mode module 508 (e.g., voltage control mode module 408) is executed including executing an error compensation function 509 to determine an error compensation value or signal 510 (e.g., error compensation signal 410).

To determine the compensator error value 510 (e.g., CompError), a summing device 423 is used to subtract the voltage threshold, Vset, 424 (e.g., Vset 302 of FIG. 3) from the sensed voltage value, Vsense, 418 according to the equation:

$$CompError = Vsense - Vset . \qquad ( Eqn . 1 )$$

A compensator & PWM generator module 511 includes compensator 411 that receives the error compensation value or signal 410, 510 and generates the error signal 412 for the PWM generator 413. Using the sawtooth signal 415, the PWM generator 413 generates PWM control signals 414, 512 for controlling the PSU 400 to generate the output voltage 405 at a target voltage determined by the Vset 302.

Returning to step 506, which compares the sensed current, Isense, with the Iset defined parameter, in response to the target Iset being reached (step 513) by the output current 404, a current source mode module 514 (e.g., current control mode module 407) is executed including executing a droop slope function 515 to determine an amount of output current increase based on the sensed output voltage, Vsense, 405. A current droop module 425 of the current control mode module 407 computes a current droop value 426 according to the equation:

$$CurrDroop = Iset \times \frac{( Vthresh - Vsense )}{Vthresh} \times DroopConst , \qquad ( Eqn . 2 )$$

where CurrDroop is the calculated current droop value, Vthresh is the defined voltage threshold, Iset is a current reference 427 (e.g., Iset 301 of FIG. 3), and DroopConst is a current share droop constant. In the case of the specific values identified in FIGS. 3, calculation of the Equation 2 includes:

$$Idroop = Iset \times \frac{( Vset - Vsense )}{Vset} \times kCSD , \qquad ( Eqn . 3 )$$

where Idroop is the calculated current droop value 426, 516.

Based on the calculated Idroop value, a summing device 428 uses an error compensation function 517 to determine an error compensation value or signal 518 (e.g., CompError) by subtracting the current threshold, Iset, 427 and the current droop value 426 from the sensed current value, Isense, 420 according to the equation:

$$CompError = Isense - Iset - Idroop . \qquad ( Eqn . 4 )$$

The calculated error compensation signal 518 is passed to the compensator & PWM generator module 511 for treatment as described above.

By subtracting the Idroop value 303 from the sensed current value, Isense, 420 in Eqn. 4, the allowed current provided to a load via the output current 404 is greater than the defined current threshold, Iset, 301 shown in FIG. 3. The value of the Idroop value 303 is inversely proportional to the sensed voltage, Vsense, 418. Accordingly, as the voltage supplied to the load via the output voltage 405 decreases, the magnitude of the Idroop value 303 increases. Therefore, as the voltage supplied to the load approaches zero, the magnitude of the Idroop value 303 approaches the value of the current share droop constant, kCSD, 304.

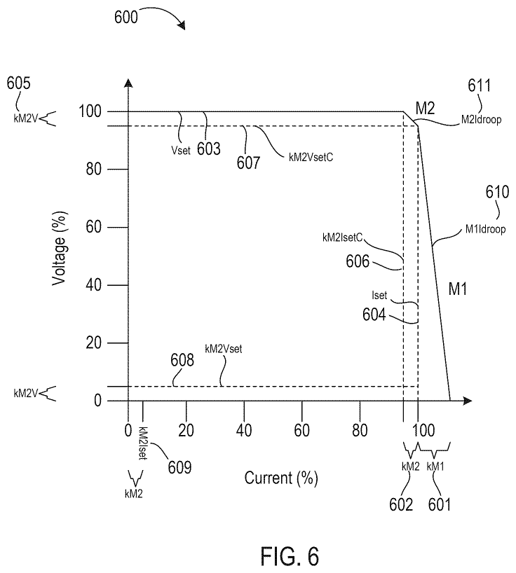

Based on differences in components, manufacturing, and other factors, the PSUs 101, 102 will not be identical. Thus, it may be that one PSU (e.g., PSU 101) may switch from the voltage source mode to the current source mode at a different time than the other PSU (e.g., PSU 102). FIG. 6 illustrates a multi-droop V-I curve 600 according to another aspect of this disclosure that presents a second slope, M2, in addition to the first slope, M1, to allow the PSUs 101, 102 to have a wider current source mode entrance range. While the V-I curve 300 above uses the abbreviation kCSD to describe the current share droop constant, the V-I curve 600 includes two constants. Thus, a first current share droop constant, kM1, 601 acts similarly to the kCSD constant discussed in FIG. 3 and defines a current value beyond 100% as shown that is used to identify a slope of the M1 portion of the V-I curve 600 used during the constant source mode. A second current share droop constant, kM2, 602 defines a current value used to identify a slope of the M2 portion of the V-I curve 600 used to transition from the voltage source mode to the current source mode. The defined voltage threshold, Vset, 603 and defined current threshold, Iset, 604 function as they are described with respect to FIG. 3 (e.g., Vset 302 and Iset 301).

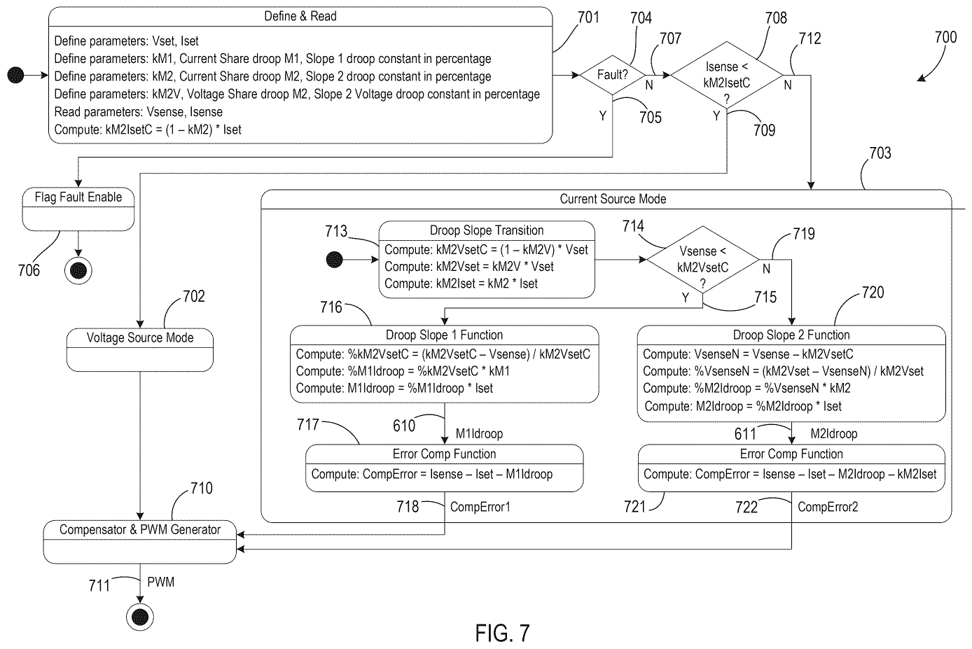

FIG. 7 illustrates a method of PSU control according to another aspect of this disclosure. Control of the PSU 400 pursuant to the V-I curve 600 of FIG. 6 will now be explained. Referring to FIGS. 4, 6 and 7, a second droop control method 700 begins at step 701 by defining and reading parameters. The thresholds Vset 603 and Iset 604 are defined as well as the slope droop constants kM1 601 and kM2 602. The slope droop constants kM1 601 and kM2 602 are percentages in one example and are current percentage values. As shown in FIG. 6, kM1 601 defines a percentage used to define the slope of the M1 curve beyond the 100% current value while kM2 602 defines a percentage used to define the slope of the M2 curve prior to the 100% current value. In addition to the value of kM1 601, the slope of the M1 curve is also based on a voltage-based droop constant, kM2V, 605 that provides a percentage value below the Vset 603 value. The voltage droop constant kM2V 605 is also defined in the define and read step 701 of the droop control method 700. The output voltage sensor 416, 417 allows the value of the Vsense 418 to be read, and the current sensing device 419 allows the value of the Isense 420 to be read. The step 701 further calculates a reference current value, kM2IsetC, 606 to be used in determining a transition point from the voltage source mode to the current source mode as the PSU 101, 102 increases in current production along the V-I curve 600. As explained below, the kM2IsetC current value 606 is used to determine whether to control the PSU according to a voltage source mode module 702 or a current source mode module 703.

However, prior to using the kM2IsetC current value 606 in a comparison step, the droop control method 700 determines (step 704) whether a fault has occurred, either in the defined and read parameters or in any other process. If a fault has occurred (step 705), a flag fault enable module 706 is executed to address the fault as required. Should the fault be one where continued operation of the PSU is still possible, process control of the method 700 may return again to step 701. If no fault has occurred (step 707) sufficient to stop the method 700, the sensed current, Isense, is compared with the reference current value, kM2IsetC, 606 at step 708. In addition, if Isense is greater than the threshold current, Iset 604, it also satisfies this comparison by being greater than the kM2IsetC current value 606. In response to the sensed current, Isense, being lower than the kM2IsetC current value 606 (step 709) (e.g., Isense has not yet reached the reference current value kM2IsetC 606), the PSU 400 is operated in its voltage source mode 702. For example, for current values less than kM2IsetC current value 606 of the V-I curve 300, the target of the output power (e.g., output power 111 or 114) is the defined voltage threshold Vset 603. Accordingly, the voltage source mode module 702 (e.g., voltage control mode module 408) is executed. As the voltage portion of the V-I curve 600 less than kM2IsetC current value 606 is constant, the voltage source mode module 702 operates in the same manner as the voltage source mode module 508 described above. That is, the value of CompError based on a difference in the Vsense and Vset values (e.g., based on Eqn. 1) is determined at step 702. Thereafter, a compensator & PWM generator module 710 operates in the same manner as described above with respect to the compensator & PWM generator module 511 of FIG. 5 to generate PWM control signals 414, 711.

Returning to step 708, which compares the sensed current, Isense, with the kM2IsetC current value 606, in response to the target kM2IsetC current value 606 being reached (step 712) by the output current 404, the current source mode module 703 is executed including a executing a droop slope transition function 713 configured to determine whether the output current 404 is within the M2 slope range or the M1 slope range. In the droop slope transition function 713, various voltage and current percentage values of the V-I curve 600 are determined.

In a first computation, a transition point voltage, kM2VsetC, 607 is determined according to the equation:

$$kM 2 VsetC = ( 1 - kM 2 V ) \times Vset , \qquad ( Eqn . 5 )$$

where kM2V is the voltage-based droop constant, kM2V, 605 and Vset is the defined voltage threshold, Vset, 603. In a second computation, a voltage percentage, kM2Vset, 608 is determined according to the equation:

$$kM 2 Vset = kM 2 V \times Vset , \qquad ( Eqn . 6 )$$

where kM2V is the voltage-based droop constant, kM2V, 605 and Vset is the defined voltage threshold, Vset, 603. In a third computation, a current percentage, kM2Iset, 609 is determined according to the equation:

$$kM 2 Iset = kM 2 \times Iset , \qquad ( Eqn . 7 )$$

where kM2 is the second current share droop constant, kM2, 602 and Iset is the defined current threshold, Iset, 604.

At step 714, the sensed output voltage, Vsense, 405 is compared with the kM2VsetC voltage value 607 to determine whether Vsense is less than the kM2VsetC voltage value 607. If Vsense is less than the kM2VsetC voltage value 607 (715), then the current source mode is maintained or put into effect, and operation along the M1 slope is determined. Accordingly, a first current droop module 716 computes a current droop value, M1Idroop, 610 based on the Eqn. 2 described above. Using the specific values of FIGS. 6 and 7 in Eqn. 2, the CurrDroop value, M1Idroop, can be found according to the equation:

$$M 1 Idroop = Iset \times \frac{( kM 2 VsetC - Vsense )}{kM 2 VsetC} \times kM 1 . \qquad ( Eqn . 8 )$$

The M1Idroop droop value 610 is used by an error compensation function 717 to determine an error compensation value or signal 718 (e.g., CompError1) according to Eqn. 4, where Idroop is the M1Idroop droop value 610. The calculated error compensation signal 718 is passed to the compensator & PWM generator module 710 for treatment as described above.

Returning to step 714, which compares Vsense to the kM2VsetC voltage value 607, if Vsense has reached (719) the kM2VsetC voltage value 607 (e.g., Vsense is greater than or equal to the kM2VsetC voltage value 607), then the current source mode is maintained or put into effect, and operation along the M2 slope is determined. Accordingly, a second current droop module, M2Idroop, 611 is computed in a second current droop module 720 based on the Eqn. 2 described above. Using the specific values of FIGS. 6 and 7 in Eqn. 2, the CurrDroop value, M2Idroop, can be found according to the equation:

$$M 2 Idroop = Iset \times \frac{( kM 2 Vset - VsenseN )}{kM 2 Vset} \times kM 2 , \qquad ( Eqn . 9 )$$

$$where VsenseN = Vsense - kM 2 VsetC .$$

The M2Idroop droop value 611 is used by an error compensation function 721 to determine an error compensation value or signal 722 (e.g., CompError2) according to Eqn. 4, where IDroop=M2Idroop−kM2Iset. The calculated error compensation signal 722 is passed to the compensator & PWM generator module 710 for treatment as described above.

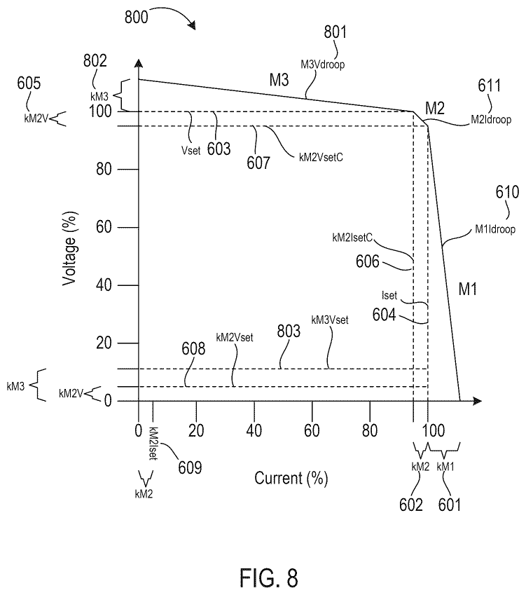

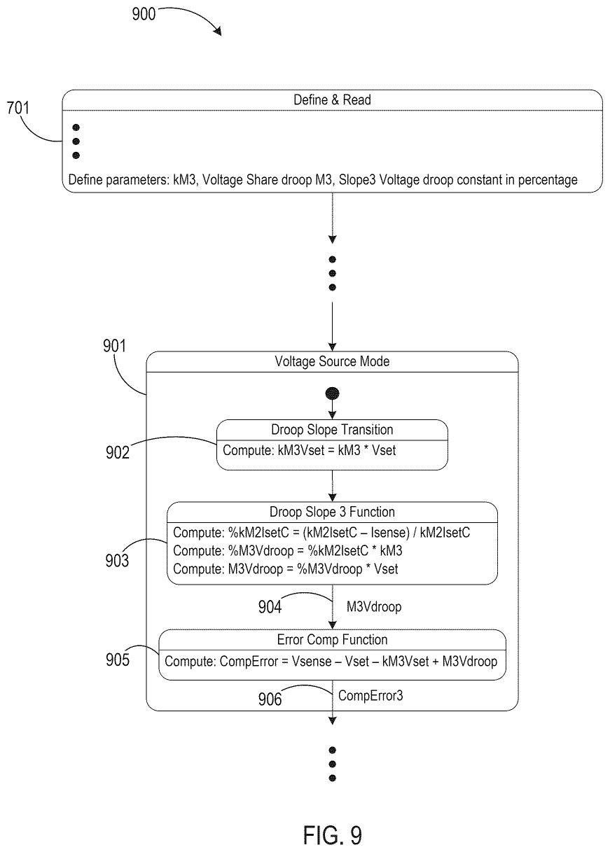

FIG. 8 illustrates a multi-droop V-I curve 800 according to another aspect of this disclosure. The multi-droop V-I curve 800 is similar to the V-I curve 600 of FIG. 6 with the addition of a voltage droop curve portion, M3Vdroop, 801. FIG. 9 illustrates a method 900 of PSU control according to the multi-droop V-I curve 800 according to another aspect of this disclosure. The values, parameters, and functions common to those already described are referenced according to their previous reference numerals, and their descriptions can be found above.

As shown in FIG. 9, the define and read function 701 from FIG. 7 includes the definitions and reads previously described as well as also including defining a voltage droop constant, kM3, 802. While most of the functions and method flow described with respect to V-I curve 600 are similar to those for the multi-droop V-I curve 800, the additional voltage droop portion M3 is addressed in an additional voltage source mode module 901 shown in FIG. 9, which may substitute the voltage source mode module 702 of FIG. 7. In the voltage source mode module 901, a droop slope transition function 902 determines a voltage percentage, kM3Vset, 803 according to the equation:

$$kM 3 Vset = kM 3 \times Vset , \qquad ( Eqn . 10 )$$

where kM3 is the voltage droop constant, kM3, 802, and Vset is the defined voltage threshold, Vset, 603.

A voltage droop module 903 (also see voltage droop module 429 of FIG. 4 shown in phantom) of the voltage source mode module 901 calculates a voltage droop signal, M3Vdroop, 904 (also see droop signal 430 of FIG. 4) using the specific values of FIGS. 8 and 9 in Eqn. 2. The CurrDroop value, M3Vdroop, can be found according to the equation:

$$M 3 Vdroop = Vset \times \frac{( kM 2 IsetC - Isense )}{kM 2 IsetC} \times kM 3. \qquad ( Eqn . 11 )$$

The M3Vdroop droop value 801 is used by an error compensation function 905 to determine an error compensation value or signal 906 (e.g., CompError3) according to the equation:

$$CompError = Vsense - Vset - kM 3 Vset + M 3 Vdroop . \qquad ( Eqn . 12 )$$

The calculated error compensation signal 906 is passed to the compensator & PWM generator module 710 for treatment as described above.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. A power supply system comprising:
a power supply configured to provide an output power to a load and configured to operate in a current source mode and in a voltage source mode, the power supply including a defined current threshold value, and a defined voltage threshold value; and
a controller coupled to the power supply and configured to:
in response to a value of an output current of the output power reaching the defined current threshold value, control the power supply to operate in its current source mode; and
while controlling the power supply to operate in its current source mode:
calculate a current droop value configured to generate a modified current threshold value that extends beyond the defined current threshold value by the current droop value;
generate a compensated pulse width modulation (PWM) signal based on a value of the output current and based on the modified current threshold value; and
operate the power supply based on the compensated PWM signal.

2. The power supply system of claim 1, wherein the controller, in being configured to operate the power supply based on the compensated PWM signal, is configured to cause the power supply to provide a modified output power to the load that comprises a modified output current greater than the defined current threshold value.

3. The power supply system of claim 1, wherein the current droop value is inversely proportional to a value of an output voltage of the output power.

4. The power supply system of claim 3, wherein the current droop value increases as the value of the output voltage decreases.

5. The power supply system of claim 1, wherein the controller is configured to calculate the current droop value via the equation:
$$Idroop = Iset \times \frac{( Vset - Vsense )}{Vset} \times kCSD$$
where:
Idroop comprises the current droop value;
Iset comprises the defined current threshold value;
Vset comprises the defined voltage threshold value;
Vsense comprises the value of the output voltage; and
kCSD comprises a droop constant.

6. The power supply system of claim 5, wherein the controller is configured to calculate an error compensation value via the equation:
$$CompError = Isense - Iset - IDroop$$
where:
CompError comprises the error compensation value; and
Isense comprises a value of an output current of the output power; and
wherein the controller is further configured to generate the compensated pulse width modulation (PWM) signal based on the error compensation value.

7. The power supply system of claim 1, wherein the controller is further configured to operate the power supply control the power supply to operate in its voltage source mode prior to the value of the output current reaching the defined current threshold value.

8. A method of controlling a power supply configured to provide an output power to a load, the power supply configured to operate in a current source mode and a voltage source mode, the method comprising:
sensing an output current of the output power via a current sensor;
sensing an output voltage of the output power via a voltage sensor;
operating the power supply in the current source mode in response to a value of the output current being greater than or equal to a first current threshold value; and
during operation of the power supply in the current source mode:
calculating a first current droop value based on a value of the output voltage and based on the first current threshold value;
calculating a first error compensation value based on:
the first current droop value;
the first current threshold value; and
the value of the output current;
generating a first compensated pulse width modulation (PWM) signal based on the first error compensation value; and
operating the power supply based on the first compensated PWM signal to provide a first modified output power to the load.

9. The method of claim 8, wherein calculating the first current droop value comprises calculating the first current droop value via the equation:
$$CurrDroop = Iset \times \frac{( Vthresh - Vsense )}{Vthresh} \times DroopConst$$
where:
CurrDroop comprises the first current droop value;
Iset comprises the first current threshold value;
Vthresh comprises a defined voltage threshold;
Vsense comprises the value of the output voltage; and
DroopConst comprises a droop constant.

10. The method of claim 8 further comprising:
operating the power supply in the current source mode in response to the value of the output current being greater than or equal to a second current threshold value, the second current threshold value being less than the first current threshold value; and
during the operation of the power supply in the current source mode:
calculating a second current droop value based on the value of the output voltage and based on the first current threshold value;
calculating a second error compensation value based on:
the second current droop value;
the first current threshold value;
the value of the output current; and
a droop current constant;
generating a second compensated PWM signal based on the second error compensation value; and
operating the power supply based on the second compensated PWM signal to provide a second modified output power to the load.

11. The method of claim 10 further comprising calculating the second current droop value based on a difference between a voltage threshold value and the value of the output voltage being less than a droop voltage constant.

12. The method of claim 10, wherein calculating the second current droop value comprises calculating the second current droop value via the equation:
$$CurrDroop = Iset \times \frac{( Vthresh - ( Vsense - kM 2 VsetC ) )}{Vthresh} \times DroopConst$$
where:
CurrDroop comprises the first current droop value;
Iset comprises the first current threshold value;
Vthresh comprises a first defined voltage threshold;
Vsense comprises the value of the output voltage;
kM2VsetC comprises a second defined voltage threshold; and
DroopConst comprises a droop constant.

13. The method of claim 8, wherein the first current droop value increases as the value of the output voltage decreases.

14. The method of claim 8 further comprising operating the power supply in the voltage source mode in response to the value of the output current being less than the second current threshold value.

15. The method of claim 8, wherein the first modified output power comprises a modified output current greater than the first current threshold value.

16. A power supply system comprising:
a first power supply configured to provide a first output power to a load, the first power supply configured to operate in a current source mode and a voltage source mode;
a first current sensor configured to provide a first current feedback signal based on an output current of the first output power;
a first voltage sensor configured to provide a first voltage feedback signal based on an output voltage of the first output power;
a first controller coupled to the first power supply, to the first current sensor, and to the first voltage sensor;
wherein the first controller is configured to:
operate the first power supply in the current source mode in response to the output current of the first output power reaching a first defined current threshold value; and
while operating the first power supply in the current source mode:
calculate a first current droop value based on a value of the first voltage feedback signal and based on the first defined current threshold value;
calculate a first error compensation value based on the first current droop value, based on the first defined current threshold value, and based on a value of the first current feedback signal;
generate a first compensated pulse width modulation (PWM) signal based on the first error compensation value; and
operate the first power supply based on the first compensated PWM signal to provide a first modified output power to the load.

17. The power supply system of claim 16, wherein the first current droop value is inversely proportional to the value of the first voltage feedback signal.

18. The power supply system of claim 17 further comprising:
a second power supply configured to provide a second output power to the load and configured to operate in the current source mode and in the voltage source mode;
a second current sensor configured to provide a second current feedback signal based on an output current of the second output power;
a second voltage sensor configured to provide a second voltage feedback signal based on and output voltage of the second output power;
a second controller coupled to the second power supply, to the second current sensor and to the second voltage sensor and configured to:
operate the second power supply in the current source mode in response to the output current of the second output power reaching a second defined current threshold value; and
while operating the second power supply in the current source mode:
calculate a second current droop value based on a value of the second voltage feedback signal and based on the second defined current threshold value;
calculate a second error compensation value based on the second current droop value, based on the second defined current threshold value, and based on a value of the second current feedback signal;
generate a second compensated pulse width modulation (PWM) signal based on the second error compensation value; and
operate the second power supply based on the second compensated PWM signal to provide a second modified output power to the load.

19. The power supply system of claim 18, wherein the first power supply further comprises a voltage output configured to transmit the first output power to the load;
wherein the second power supply further comprises a voltage output configured to transmit the second output power to the load; and
wherein the voltage output of the first power supply and the voltage output of the second output power are coupled together in series.

20. The power supply system of claim 16, wherein the first controller is further configured to:
calculate a voltage droop value based on a value of the first current feedback signal and based on the first defined voltage threshold value;
generate a second compensated PWM signal based on the voltage droop value; and
operate the first power supply based on the second compensated PWM signal to provide a second modified output power to the load.
